(19) United States
(12) Patent Application Publication
(10) Pub. No.: US 2016/0197766 A1
(43) Pub. Date: Jul. 7, 2016

(54) SOFT REDUNDANCY PROTOCOL

(71) Applicant: SIEMENS AKTIENGESELLSCHAFT, Munich (DE)

(72) Inventors: Vivek Kulkarni, Unterhaching (DE); Andreas Scholz, Unterschleissheim (DE)

(73) Assignee: SIEMENS AKTIENGESELLSCHAFT, Munich (DE)

(21) Appl. No.: 14/908,904

(22) PCT Filed: Jun. 24, 2014
(86) PCT No.: PCT/EP2014/063305

§ 371 Date: Jan. 29, 2016

(30) Foreign Application Priority Data
Jul. 31, 2013 (DE) 10 2013 215 035.0

(51) Int. Cl. H04L 12/24; H04L 12/703; H04L 12/437

(52) U.S. Cl. CPC H04L 41/0654; H04L 12/437; H04L 45/28

(57) ABSTRACT

A network including network nodes that are arranged in a ring topology. At least one of the network nodes includes middleware. The middleware includes a redundancy protocol that is implemented on the application level in a network stack. In order to ensure a functional capability of the network, the ring topology is monitored with the redundancy protocol.

### CROSS REFERENCE TO RELATED APPLICATIONS

This application is based on and hereby claims priority to International Application No. PCT/EP2014/063305 filed on Jun. 24, 2014 and German Application No. 10 2013 215 035.0 filed on Jul. 31, 2013; the contents of both are hereby incorporated by reference.

### BACKGROUND

Communication middleware is used in many systems as a basis for implementing monitoring or control solutions. Below, the Data Distribution Service (DDS) is used to represent the multiplicity of these middleware solutions, and the Media Redundancy Protocol (MRP) is used to represent redundancy protocols. The fundamental principles of DDS can be found at http://portals.omg.org/dds/content/page/specifications. MRP has been defined in the IEC 62439 standard of the International Electrotechnical Commission since April 2008.

Redundant topologies, e.g. rings, are used to ensure the functional capability of the communication network even in the event of faults on individual lines. The management of these topologies is performed by redundancy protocols, such as, for example, the Media Redundancy Protocol (MRP).

MRP is currently implemented on the network components, usually together with further communication stacks, such as Profinet, on managed switches, such as e.g. the Siemens SCALANCE.

MRP (and similar protocols) are implemented in such a way that they perform the fault handling transparently for the overlying layers, i.e. in this case middleware systems. This is achieved by implementing the protocols on the network components, i.e. switches. This drives up the costs for the network components because, along with the pure network functions, investment must also be made in processing power and memory for the implementation of the redundancy protocols.

### SUMMARY

Various embodiments described herein relate to redundancy protocols for a network including at least one ring topology.

Various embodiments described herein provide for reducing the costs for network components and/or enable a simplification of the design of network components.

Various embodiments described herein relate to middleware. The middleware includes a redundancy protocol. The redundancy protocol is implemented in a network stack on the application level.

Various embodiments described herein relate to a method for ensuring a functional capability of a network. The network includes a ring topology. The method includes monitoring of the ring topology by using a redundancy protocol. The redundancy protocol includes middleware. The redundancy protocol is implemented in a network stack on the application level.

Various embodiments described herein relate to a network. The network includes a plurality of network nodes. The network nodes are arranged in a ring topology. At least one of the network nodes includes middleware. The middleware includes a redundancy protocol to ensure a functional capability of the ring topology. The redundancy protocol is implemented on the application level in a network stack.

Various embodiments described herein provide for reducing the required system costs by implementing a redundancy protocol, not on the network level, but as a subfunction of the middleware that is used. This (usually incurring losses in terms of response speed) allows the function of a redundancy protocol, such as, for example, MRP, to be implemented in “application software” and, in return, less costly standard components to be used in the network.

### BRIEF DESCRIPTION OF THE DRAWINGS

These and other objects and advantages will become more apparent and more readily appreciated from the following description of the various embodiments, taken in conjunction with the accompanying drawings of which:

FIG. 1 is a schematic diagram of a network according to an embodiment;

FIG. 2 is a schematic diagram of the network from FIG. 1 with a destroyed ring topology;

FIG. 3 is a schematic diagram of a network node of the network from FIGS. 1 and 2 designed as a redundancy manager; and

FIG. 4 is a schematic diagram of the redundancy manager from FIG. 3 in a stack view.

### DETAILED DESCRIPTION OF THE PREFERRED EMBODIMENTS

Reference will now be made in detail to the various embodiments, examples of which are illustrated in the accompanying drawings, wherein like reference numerals refer to like elements throughout.

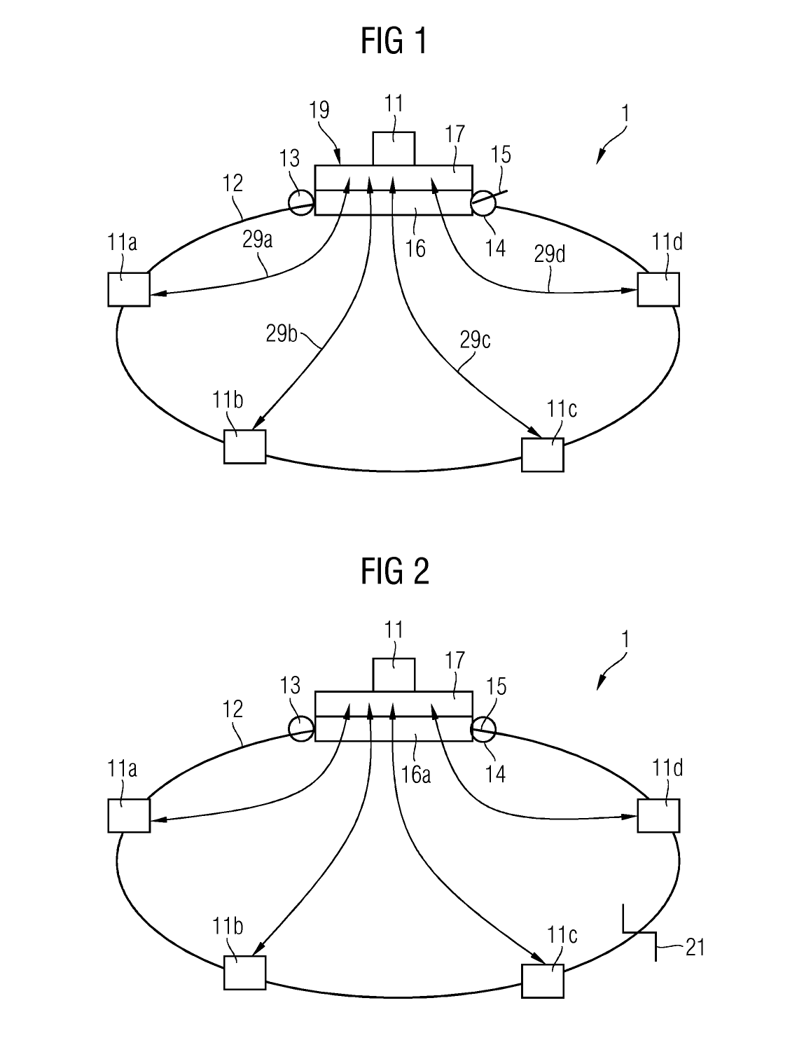

FIGS. 1 to 4 illustrate a network 1 according to an embodiment of the invention.

FIG. 1 shows the network 1 according to an embodiment of the invention. The network 1 includes a plurality of network nodes 11, 11a, 11b, 11c, 11d, which are arranged in a ring topology 12. In the embodiment shown, the ring topology 12 includes the entire network 1. However, in further variants of the embodiment, individual or all of the network nodes 11, 11a, 11b, 11c, 11d can additionally be connected to further network nodes or network parts (not shown), which are not part of the ring topology 12.

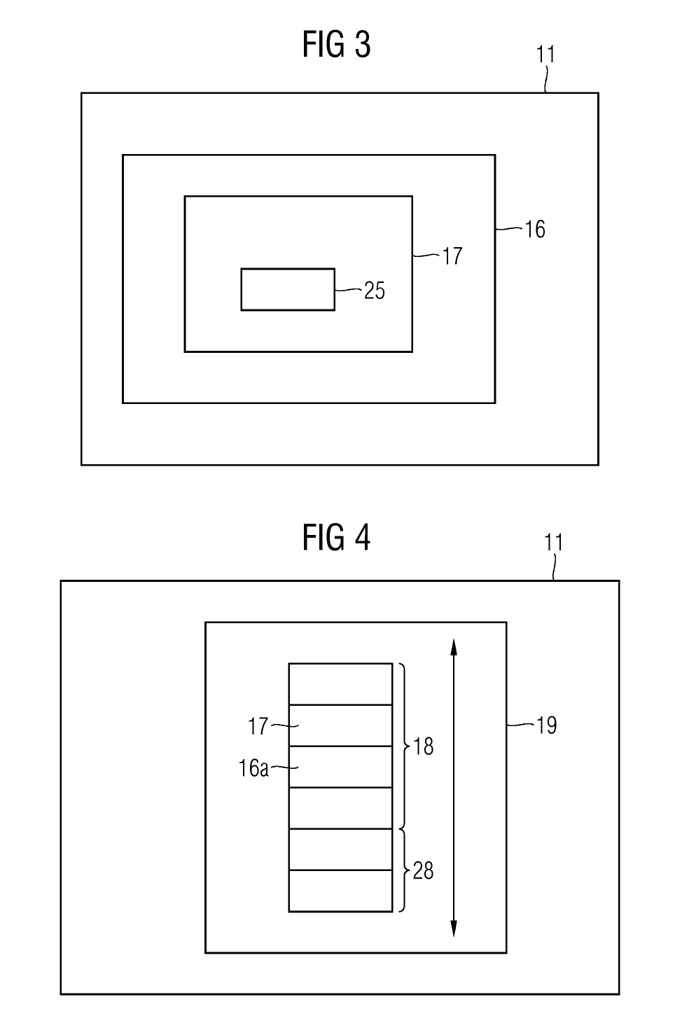

At least one, a plurality or each of the network nodes 11, 11a, 11b, 11c, 11d includes middleware. In FIG. 3, the network node 11, for example, is shown in more detail. The network node 11 includes the middleware 16. The middleware 16 includes a redundancy protocol 17. The redundancy protocol 17 is implemented on the application level 18 in a network stack 19. This is also evident in FIG. 1, since the redundancy protocol 17 designed as MRP is implemented in the network stack 19 via a middleware protocol 16a designed as a DDS protocol.

With reference to FIG. 1, the arrows 29a-d represent logical communication connections between the middleware components of the individual network nodes 11, 11a, 11b, 11c, 11d, which serve to exchange status information relating to the network 1, i.e. indicating the communication connections which are functional and those which are not. The communication between the network nodes 11, 11a, 11b, 11c, 11d can be two-way. A monitoring function of this type is often a component of the middleware and, if available, may also be used. If not available, the monitoring function is implemented as a component of the redundancy protocol 17.

According to the embodiment shown with reference to FIGS. 1 to 4, the redundancy protocol 17 includes an interrupt function 25 (see FIG. 3). The interrupt function 25 is designed to cause the logical interruption 15 of the ring topology 12, for example by deactivating the port 14 of the network node 11.

FIG. 2 shows the network 1 from FIG. 1 with a (for example physically) destroyed ring topology 12, this being caused by the interruption 21 between the network nodes 11c and 11d. If the port 14 is interrupted as shown in FIG. 1, a connection no longer exists to the network node 11d, i.e. the network node 11d is no longer contactable from the perspective of the middleware. This circumstance is detected by the monitoring function and reported to the network node 11. The redundancy protocol on the network component 11 carries out operations in order to compensate for the failure and therefore in this embodiment activates the port 14. In the resulting network from FIG. 2, all network nodes 11, 11a, 11b, 11c, 11d are again contactable.

FIG. 3 shows the network node 11 in a more detailed representation. The network node 11 of the ring topology 12 designed as the redundancy manager 11 includes the middleware 16. The middleware 16 includes a redundancy protocol 17. The redundancy protocol 17 serves to ensure a functional capability of the ring topology 12. To do this, the implementation of the redundancy protocol includes the interrupt function 25.

FIG. 4 shows the network node 11 from FIG. 3 in a stack view. A network stack 19 is implemented in the network node 11. The network stack 19 includes an application level 18, and also lower-lying levels 28, such as, for example, the transport level (TCP) and the network level (IP). Protocols 16a for the application of the middleware 16 and also the redundancy protocol 17 are implemented on the application level 18. The redundancy protocol 17, and also middleware protocols 16a, are implemented on the application level 18 in the network stack 19.

The ring topology 12 is monitored by the redundancy protocol 17 in order to ensure the functional capability of the network 1.

The redundancy protocol can be designed to remove the logical interruption 15 if the ring topology 12 is destroyed.

The redundancy protocol 17 can be designed to cause the logical interruption 15 of the ring topology 12 if an interruption 21 of the ring topology 12 has been removed.

The redundancy protocol 17 can be a Media Redundancy Protocol (MRP) according to the IEC 62439 standard of the International Electrotechnical Commission.

The middleware 16 can include or is an implementation of the Data Distribution Standard (also referred to as the Data Distribution Service Standard) of the Object Management Group (OMG).

The middleware can be implemented in at least one further of the network nodes 11a, 11b, 11c, 11d or in a plurality of the network nodes 11, 11a, 11b, 11c, 11d or in all of the network nodes 11, 11a, 11b, 11c, 11d of the ring topology 12 with the redundancy protocol 17 on the application level 18. It is possible to implement the network software in all network nodes 11, 11a, 11b, 11c, 11d. In the event of an interruption 21, all network nodes 11, 11a, 11b, 11c, 11d are then contactable by the implemented middleware 16 or the redundancy protocol implemented in the middleware. If only some of the network nodes 11, 11a, 11b, 11c, 11d have implemented the middleware with the redundancy protocol 17 on the application level 18, the embodiment still functions, since the communication between the middleware components on these nodes can still take place even in the event of an interruption 21.

The redundancy protocol 17 is implemented in the middleware 16, i.e. on the application level 18 in the network stack 19.

Below, the Data Distribution Service (DDS) is used to represent the multiplicity of middleware solutions, and the Media Redundancy Protocol (MRP) is used to represent redundancy protocols.

MRP requires a ring topology 12 in the network, as shown in FIG. 1. The MRP manager 11, which must be present in each network, monitors the status of the ring 12 by causing special data packets to circulate in the ring 12. As long as these packets reach the manager 11, it is ensured that all network connections are intact. It is crucial for the operation of Ethernet that the network 1 is non-circular. The MRP manager 11 therefore “interrupts” the network 1 at one of its two network ports 13, 14 by the logical interruption 15 and thereby generates a non-circular line topology (the special packets for monitoring can, however, pass through the interruption 15).

In the event of a fault, i.e. when the circulating monitoring packets are absent, the MRP manager 11 removes the logical interruption 15 once more. This is permissible since the network 1 is interrupted in at least one other place 21, which has resulted in the absence of the monitoring packets. A line topology is therefore created once more through the removal of the blocking 15.

DDS uses a data-driven approach. The communication connections that are set up by DDS in the network are created by DDS users making data available and other users registering an interest in these data. The connection between the producers and users is loose, i.e. users do not know who has produced the data and producers do not know who communicates the data. This disconnect enables new participants to be incorporated simply into the network and also offers good scalability.

However, in contrast to a known client-server approach, additional tasks relating to the monitoring of participants must be performed by the DDS middleware. In a client-server architecture, the monitoring of participants (i.e. monitoring whether all participants are still contactable) can easily be performed by the server because the latter knows all those who are interested in data. The failure of the server is in turn easily detected by the clients, since the latter cannot obtain a connection to the server. Due to the loose connection in DDS, this is no longer provided and the middleware itself must perform the monitoring of the network participants. This takes place through the regular transmission of heartbeats by the middleware from the individual nodes, or through similar mechanisms.

A network 1 designed, for example, as a soft MRP system, as shown in FIG. 2, can be produced, for example, by implementing the port interrupt function 25 as in MRP on the basis of the monitoring mechanism of middleware 16 designed as DDS on one of the ring participants 11 (soft MRP manager). Similar to the mode of operation of MRP installed on a switch, the interruption 15 is removed, according to embodiments described herein, as soon as the DDS monitoring service reports that nodes/connections have failed, and is restored as soon as the failure 21 is eliminated.

A known MRP implemented at the MAC layer guarantees significantly faster response times in the event of failures (monitoring in DDS uses longer timeouts due to the architecture).

A known MRP implemented at the MAC layer requires “intelligent” network components, which incur higher costs than standard components.

A known MRP implemented at the MAC layer works transparently and independently from overlying network layers. Embodiments described herein are based on soft MRP require a presence of middleware.

Embodiments described herein are based on soft MRP and therefore represent an economical replacement for known MRP implemented at the MAC layer for all fields of application in which middleware solutions such as DDS are used. In these fields of application, the response time of soft MRP is sufficient, since soft MRP uses the monitoring of DDS, automatically scales the response time in the event of a fault with the requirements of a specific system since the monitoring in DDS is configured on the basis of these requirements.

The use of soft MRP is advantageous for fields of application that are cost-sensitive (SMART products) and/or non-real-time applications.

Embodiments described herein exploit the fact that communication middleware, such as, for example, DDS, imposes different requirements on communication networks such as, for example, an automation application implemented with current technology, but is increasingly used in the same field of application (industrial plants). The existing solution (MRP on the network level) can therefore be replaced with an alternative, less costly solution (MRP on the middleware level) for these new fields of application.

The soft MRP solution according to the various embodiments described herein does not represent a generally valid replacement for the existing implementation of MRP, since, on the one hand, it is suitable for specific fields of application only (in which DDS is used) and, on the other hand, also achieves poor response times in the event of a fault. However, if these response times are tolerable and if the field of application exists, significant cost savings can then be achieved in the network components.

The various embodiments have been described in detail with particular reference and examples, but it will be understood that variations and modifications can be effected within the spirit and scope of the various embodiments covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-19. (canceled)

20. Middleware, comprising:
a redundancy protocol that is implemented on an application level in a network stack.

21. The middleware as claimed in claim 20, wherein the redundancy protocol includes an interrupt function that is designed to cause a logical interruption of a ring topology of a network.

22. The middleware as claimed in claim 21, wherein the redundancy protocol is designed to remove the logical interruption when the ring topology is destroyed.

23. The middleware as claimed in claim 21, wherein the redundancy protocol is designed to cause the logical interruption of the ring topology when an interruption in the network has been removed.

24. The middleware as claimed in claim 20, wherein the redundancy protocol is a Media Redundancy Protocol and the middleware includes an implementation of the Data Distribution Standard.

25. A method for ensuring a functional capability of a network including a ring topology, the method comprising:
monitoring the ring topology with a redundancy protocol, the redundancy protocol being included in middleware and being implemented on an application level in a network stack.

26. The method as claimed in claim 25, wherein the middleware is implemented in a network node of the ring topology and the network node is a redundancy manager.

27. The method as claimed in claim 25, wherein the redundancy protocol includes an interrupt function that is designed to cause a logical interruption of the ring topology.

28. The method as claimed in claim 27, wherein the redundancy protocol is designed to remove the logical interruption when the ring topology is destroyed.

29. The method as claimed in claim 27, wherein the redundancy protocol is designed to cause the logical interruption of the ring topology when an interruption of the ring topology has been removed.

30. The method as claimed in claim 25, wherein the redundancy protocol is a Media Redundancy Protocol and the middleware includes an implementation of the Data Distribution Standard.

31. The method as claimed in claim 25, wherein the middleware is implemented in at least one of a plurality of network nodes included in the ring topology with the redundancy protocol on the application level.

32. A network, comprising:
network nodes arranged in a ring topology, at least one of the network nodes including middleware with a redundancy protocol implemented on an application level in a network stack.

33. The network as claimed in claim 32, wherein the at least one of the network nodes is a redundancy manager.

34. The network as claimed in claim 32, wherein the redundancy protocol causes a logical interruption of the ring topology.

35. The network as claimed in claim 34, wherein the logical interruption of the ring topology is caused by deactivating a port of the at least one of the network nodes.

36. The network as claimed in claim 35, wherein the logical interruption of the ring topology is removed by reactivating a port of the at least one of the network nodes when the ring topology is destroyed.

37. The network as claimed in claim 34, wherein the redundancy protocol removes the logical interruption when the ring topology is destroyed.

38. The network as claimed in claim 34, wherein the redundancy protocol causes the logical interruption of the ring topology when an interruption of the ring topology has been removed.

39. The network as claimed in claim 32, wherein the redundancy protocol is a Media Redundancy Protocol (MRP) and the middleware includes an implementation of the Data Distribution Standard.

40. The network as claimed in claim 32, wherein all of the network nodes of the ring topology include an implementation of the middleware with the redundancy protocol on an application level.

41. A non-transitory computer-readable medium encoded with a computer program for a functional capability of a network including a ring topology, the program when executed by a computer causes the computer to perform a process comprising:
monitoring the ring topology with a redundancy protocol, the redundancy protocol being included in middleware and being implemented on an application level in a network stack of at least one network node included in the network.
